(19) United States
(12) Patent Application Publication
(10) Pub. No.: US 2015/0112683 A1
(43) Pub. Date: Apr. 23, 2015

(54) DOCUMENT SEARCH DEVICE AND DOCUMENT SEARCH METHOD

(71) Applicants: Yoichi Fujii, Tokyo (JP); Jun Ishii, Tokyo (JP)

(72) Inventors: Yoichi Fujii, Tokyo (JP); Jun Ishii, Tokyo (JP)

(73) Assignee: Mitsubishi Electric Corporation, Tokyo (JP)

(21) Appl. No.: 14/364,174

(22) PCT Filed: Dec. 27, 2012
(86) PCT No.: PCT/JP12/83925

§ 371 Date: Jun. 10, 2014

(30) Foreign Application Priority Data
Mar. 13, 2012 (JP) 2012-055841

(51) Int. Cl. G10L 15/18

(52) U.S. Cl. CPC G10L 15/1822
USPC 704/254

(57) ABSTRACT

An utterance content estimator estimates a document ID corresponding to an answer to user input analysis results from a document on the basis of an utterance estimating model that is generated by learning a correspondence between hypothetical questions each as to a content of the document and document IDs each of which is an answer to one of the hypothetical questions. A result integrator integrates document estimation results of the utterance estimating model and document search results of search indexes so as to generate final search results.

### FIELD OF THE INVENTION

The present invention relates to a document search device for and a document search method of searching through fine units of an electronized document, such as chapters, paragraphs, and sections.

### BACKGROUND OF THE INVENTION

To each of many pieces of equipment, such as home electrical appliances and pieces of vehicle-mounted equipment, a paper operation manual in which operating procedures, information about what to do in case of trouble, etc. are described is attached. For an information device among many pieces of equipment, an operation manual is electronized so that the user is enabled to directly make a search for and browse a desired content. As a result, the user is enabled to browse his or her desired content without taking the trouble to carry a paper document. In contrast, an electronized document has a low degree of at-a-glance readability, and it is difficult for the user to search for a content which he or she desires to check. Therefore, it is indispensable to provide a search function for such an information device.

As the simplest one of typical conventional search functions, there is a GREP search method of performing a search by using a keyword and displaying hits in the order that they appear in the document from the head of the document. In addition, there is a boolean search method of generating search indexes from a document and extracted keywords in advance, performing a search based on a logical formula by using the search indexes, and displaying candidates. Further, because according to the boolean search method, a score showing the degree of association between an input keyword and a search index cannot be defined, there is provided a best matching search method of simply inputting a keyword, and determining a score by counting the frequency of appearance of the keyword. In addition, there is a statistical search method of generating search indexes, to each of which a statistical weight, such as tf-idf (term frequency and inverse document frequency), is added, from keywords, performing a search by using a vector distance (inner product) between each of the search indexes and an input keyword, and displaying candidates. The provision of these search methods makes it possible for the user to search through an electronized document, and to browse a part of the document, which the user desires, to some extent.

Because according to the boolean search method, only parts strictly matching a search criterion are searched for, while the boolean search method has the merit of being easy to find parts matching the user's search intention when making full use of a complicated search criterion, the boolean search method has the demerit of being easy to result in increase in the number of parts dropped out of search results when the search criterion is not more appropriate. Further, constructing a complicated search formula also has the demerit of imposing a high hurdle on general users. Therefore, the most typical boolean search is a method of causing the user to input two or more keywords and determining search results by implementing an OR logical operation, and presenting the search results. In contrast, while the best matching search method and the statistical search method have the merit of being able to perform a search without having to insert a logical structure into keywords, the methods have the demerit of making it difficult for the user to control the search because the frequency of appearance of each keyword in the document is scored simply, and a score is calculated from a value which is weighted according to the tendency of appearance of each keyword.

As a method of taking advantage of the merits of both the methods in consideration of the merits and demerits of the methods, a method of integrating a plurality of search engines and carrying out processing has been proposed. For example, patent reference 1 discloses a method of independently executing the boolean search method and the statistical search method, or the best matching search method and the statistical search method, and logically integrating the search results acquired by the methods to perform a search.

Concretely, only information about candidates for the search results can be acquired by a search engine using the boolean search method, while candidates for the search results and their scores can be acquired as information by a search engine using the best matching search method and the statistical search method. When the boolean search method and the statistical search method are combined, for example, only a result included in the logical formula type search results and having the same document ID as that included in the statistical search results is determined as a final result candidate, and, after all document IDs included in the logical formula type search results and all document IDs included in the statistical search results are determined as final result candidates, the scores in the statistical search results are used to rank the final results.

In addition, when the best matching search method and the statistical search method are combined, the final results are ranked by using the average of scores.

Further, there is proposed a conventional search method of generating a table of synonyms and near-synonyms in order to reduce cases in which nothing can be searched for due to a superficial difference between keywords, and expanding each keyword in the search criterion into synonyms and near-synonyms so as to perform a search.

### RELATED ART DOCUMENT

### Patent Reference

Patent reference 1: Japanese Unexamined Patent Application Publication No. Hei 10-143530

### SUMMARY OF THE INVENTION

### Problems to be Solved by the Invention

Because conventional document search devices and conventional document search methods are configured as above, search results which the user desires can be acquired more easily as compared with the case of performing a search by using a single search method. However, because in these search methods the target for the extraction of keywords for generating search indexes is the document itself which is the search target, the search methods are based on a search for keywords appearing in the document even when using a single search method and even when using a combination of a plurality of search methods.

Further, because the user who performs a search has to input a search criterion in a state of not identifying keywords used in the document in an actual search situation, a problem of being unable to look up a desired document occurs. In order to solve this problem, a search with expansion into synonyms and near-synonyms is performed, so that some improvement can be expected. However, a document, such as an operation manual, has an explanation using technical terms and special terms associated with a specific function for the purposes of accuracy in many cases, there occurs a situation in which a general user and an entry level user who wants to know how to use the product do not understand what keyword should be inputted to perform a search in order to get a desired explanation in many cases. Concretely, terms showing the direction of a map for car navigation, such as “north up” and “heading up”, are keywords which cannot be expected by beginner users of car navigation. Therefore, when such a user performs a search by inputting a criterion “I want to change the map the direction we are going is upwards.”, a case of not providing any desired search results occurs because no appropriate keywords exist.

The present invention is made in order to solve the above-mentioned problem, and it is therefore an object of the present invention to provide a technique of presenting search results more appropriate than those presented by a simple search method in response to a user input in natural language.

### Means for Solving the Problem

In accordance with the present invention, there is provided a document search device including: search indexes generated from a document which is prepared in advance; a document searcher that receives an input from a user and searches through the document for an item associated with the user input by using the search indexes; an utterance estimating model that is generated by learning a correspondence between hypothetical questions each as to a content of the document and items in the document each of which is an answer to one of the hypothetical questions; an utterance content estimator that estimates an item corresponding to an answer to the user input from the document on a basis of the utterance estimating model; and a result integrator that integrates document search results acquired from the document searcher and document estimation results acquired from the utterance content estimator so as to generate final search results.

In accordance with the present invention, there is provided a document search method including: a user input step of accepting an input from a user; a document searching step of searching through the document for an item associated with the user input by using search indexes generated from a document which is prepared in advance; an utterance content estimating step of estimating an item corresponding to an answer to the user input from the document on a basis of an utterance estimating model that is generated by learning a correspondence between hypothetical questions each as to a content of the document and items in the document each of which is an answer to one of the hypothetical questions; and a result integrating step of integrating document search results acquired from the document searching step and document estimation results acquired from the utterance content estimating step so as to generate final search results.

### ADVANTAGES OF THE INVENTION

Because in accordance with the present invention, an item corresponding to an answer to the user input is estimated from the document by using the utterance estimating model which is generated by learning the correspondence between questions generated by expecting what question the user asks and document items each of which is an answer to one of the questions, and the estimation results are integrated with the results of the index search, search results more suitable as compared with results acquired by using a simple search method can be presented in response to a user input in natural language.

### BRIEF DESCRIPTION OF THE FIGURES

FIG. 1 is a block diagram showing the structure of a document search device in accordance with Embodiment 1 of the present invention;

FIG. 2 is a view showing an example of a document which is handled by the document search device in accordance with Embodiment 1;

FIG. 3 is a view showing the results of a document analysis carried out by the document search device in accordance with Embodiment 1, and an example of a keyword list for search indexes;

FIG. 4 is a view showing an example of collected utterance data which is provided by the document search device in accordance with Embodiment 1;

FIG. 5 is a view showing the results of a collected utterance analysis carried out by the document search device in accordance with Embodiment 1, and an example of a keyword list for utterance estimating models;

FIG. 6 is a flow chart showing an operation of generating search indexes from a document which is handled by the document search device in accordance with Embodiment 1;

FIG. 7 is a flow chart showing an operation of generating an utterance estimating model from collected utterance data which is provided by the document search device in accordance with Embodiment 1;

FIG. 8 is a flow chart showing an operation of generating a final search result from a user input of the document search device in accordance with Embodiment 1;

FIG. 9 is a view showing an example of a transition of a user input in the document search device in accordance with Embodiment 1;

FIG. 10 is a view showing a continuation of the example of the transition of the user input shown in FIG. 9;

FIG. 11 is a block diagram showing the structure of a document search device in accordance with Embodiment 2 of the present invention;

FIG. 12 is a view showing hierarchical layers of a document which is handled by the document search device in accordance with Embodiment 2;

FIG. 13 is a flow chart showing an operation of generating a final search result from a user input of the document search device in accordance with Embodiment 2;

FIG. 14 is a view showing an example of a transition of a user input in the document search device in accordance with Embodiment 2;

FIG. 15 is a view showing an example of a document which is handled by a document search device in accordance with Embodiment 3;

FIG. 16 is a view showing the results of a document analysis carried out by the document search device in accordance with Embodiment 3, and an example of a keyword list for search indexes;

FIG. 17 is a view showing an example of collected utterance data which is provided by the document search device in accordance with Embodiment 3;

FIG. 18 is a view showing the results of a collected utterance analysis carried out by the document search device in accordance with Embodiment 3, and an example of a keyword list for utterance estimating models;

FIG. 19 is a view showing an example of a transition of a user input in the document search device in accordance with Embodiment 3;

FIG. 20 is a view showing a continuation of the example of the transition of the user input shown in FIG. 19;

FIG. 21 is a view showing an example of a document which is handled by a document search device in accordance with Embodiment 4;

FIG. 22 is a view showing the results of a document analysis carried out by the document search device in accordance with Embodiment 4, and an example of a keyword list for search indexes;

FIG. 23 is a view showing an example of collected utterance data which is provided by the document search device in accordance with Embodiment 4;

FIG. 24 is a view showing the results of a collected utterance analysis carried out by the document search device in accordance with Embodiment 4, and an example of a keyword list for utterance estimating models;

FIG. 25 is a view showing an example of a transition of a user input in the document search device in accordance with Embodiment 4; and

FIG. 26 is a view showing a continuation of the example of the transition of the user input shown in FIG. 25.

### EMBODIMENTS OF THE INVENTION

Hereafter, in order to explain this invention in greater detail, the preferred embodiments of the present invention will be described with reference to the accompanying drawings.

### Embodiment 1

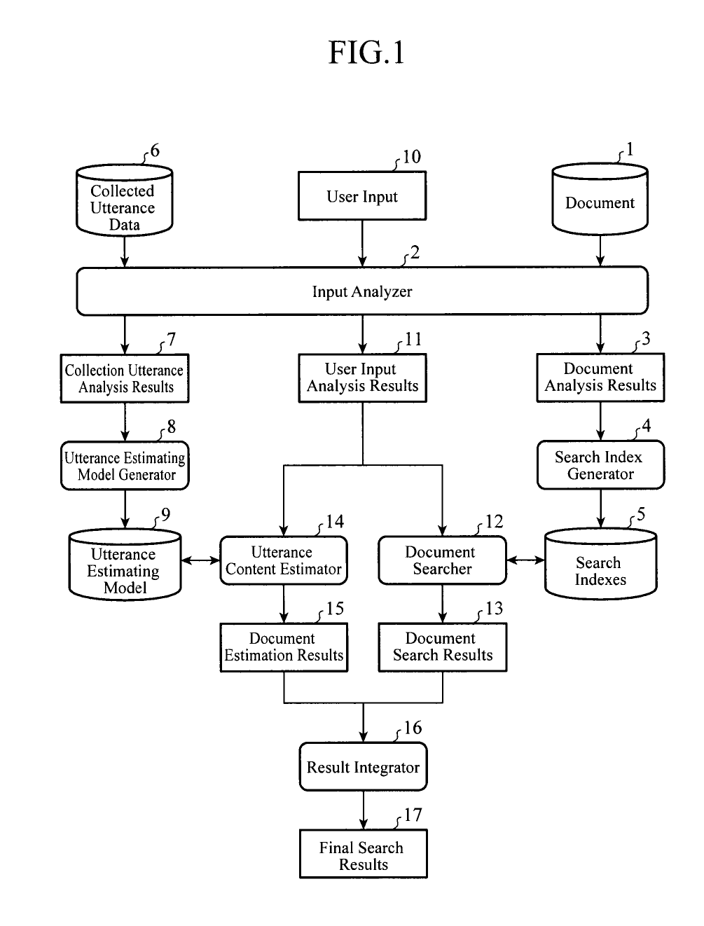

Hereafter, an embodiment of the present invention will be explained with reference to drawings. FIG. 1 is a block diagram showing the structure of a document search device in accordance with this Embodiment 1. A document 1 is text data including an electronized text, such as an electronized operation manual of a product. It is assumed that this document 1 is divided into up to some hierarchical layers, such as a chapter layer, a paragraph layer, and a section layer, according to the functions of the product. An input analyzer 2 divides a text, such as the document 1, into morphemes by using a method such as a morphological analysis method which is a known technique. Document analysis results 3 are data in which the document 1 is divided into morphemes by the input analyzer 2.

A search index generator 4 generates search indexes 5 from the document analysis results 3. Each of these search indexes 5 returns an item in the document 1, such as a specific chapter, a specific paragraph, or a specific section, as a search result, in response to an input of a keyword from a document searcher 12. Collected utterance data 6 are acquired by collecting something to ask when using the document 1 by using a method of obtaining information by means of questionnaires or the like in advance. It is assumed that a generating method of generating collected utterance data 6 includes the steps of generating questions from the functions of the product which are described in the document 1 in advance, and collecting questions to ask in advance by means of questionnaires or the like. Collected utterance analysis results 7 are data in which the collected utterance data 6 are divided into morphemes by the input analyzer 2.

An utterance estimating model generator 8 carries out statistical learning by defining, as a learning unit (feature), each of the morphemes of the collected utterance analysis results 7, so as to generate an utterance estimating model 9. This utterance estimating model 9 receives a morpheme string of the collected utterance analysis results 7 as an input, and is learning result data for returning items each corresponding to an answer to one of the above-mentioned questions as utterance content estimation results while adding a score to each of the items.

A user input 10 is data showing an input from a user to the document search device. Hereafter, the explanation will be made assuming that the user input 10 is a text input. User input analysis results 11 are data in which the user input 10 is divided into morphemes by the input analyzer 2.

The document searcher 12 receives the user input analysis results 11 as an input, and performs a search by using the search indexes 5 so as to generate document search results 13. An utterance content estimator 14 receives the user input analysis results 11 as an input, and estimates an item corresponding to this input by using the utterance estimating model 9 and acquires the document ID of the item. Document estimation results 15 are data including the document ID estimated by the utterance content estimator 14 and its score (which will be mentioned below).

A result integrator 16 integrates the document search results 13 and the document estimation results 15 into single search results, and outputs the search results as final search results 17.

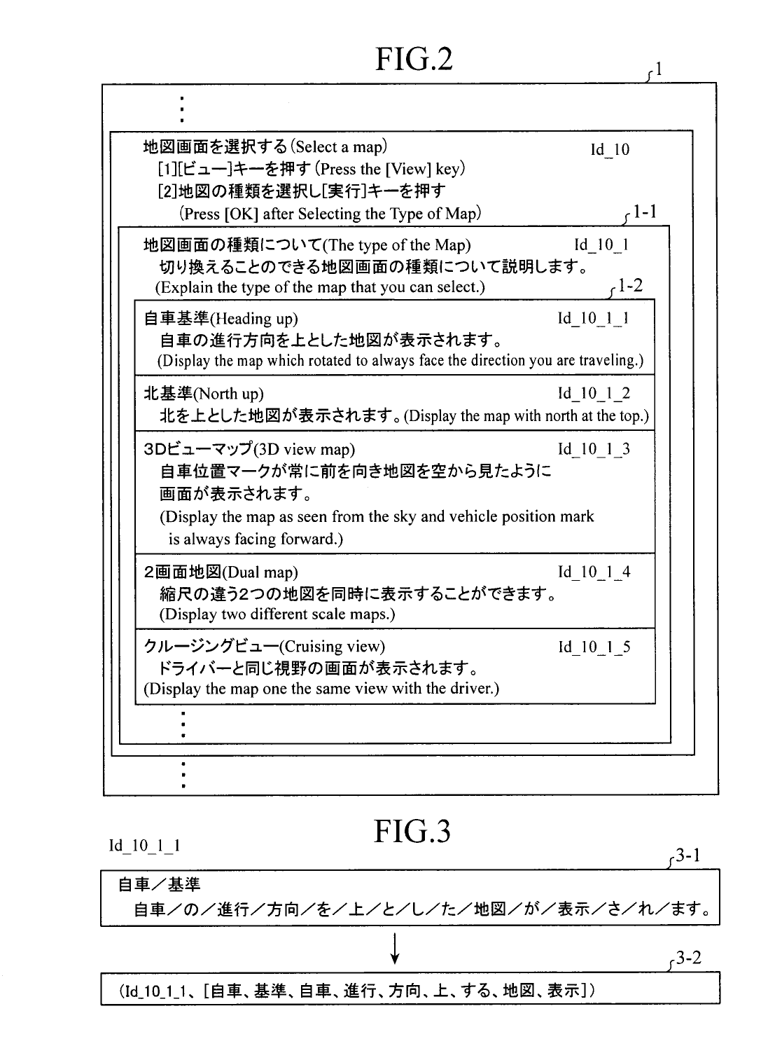

FIG. 2 shows an example of the document 1. The document 1 has a structure of hierarchical layers, such as a chapter layer, a paragraph layer, and a section layer, and has a document ID showing a search result position for each hierarchical layer. In the example shown in FIG. 2, a document 1-1 having a document ID of “Id_{—}10_{—}1” also includes texts included in a lower layer data structure. For example, the figure shows that a document 1-2 of “Id_{—}10_{—}1_{—}1” is also included in the document 1-1 of “Id_{—}10_{—}1.”

FIG. 3 shows an example of the document analysis results 3 and a keyword list for the search indexes 5. “Id_{—}10_{—}1_{—}1” is an example of document analysis results 3-1, and shows the results of carrying out an input analysis according to a morphological analysis on the document 1-2 of “Id_{—}10_{—}1_{—}1” shown in FIG. 2. In these document analysis results 3-1, the sections of the morphological analysis results are separated by “/.” Data 3-2 for search indexes shows an example of data which is generated on the basis of the document analysis results 3-1 of “Id_{—}10_{—}1_{—}1” and which the search index generator 4 uses. In this embodiment, the document ID and a list of general forms (keywords) of independent word morphemes are extracted.

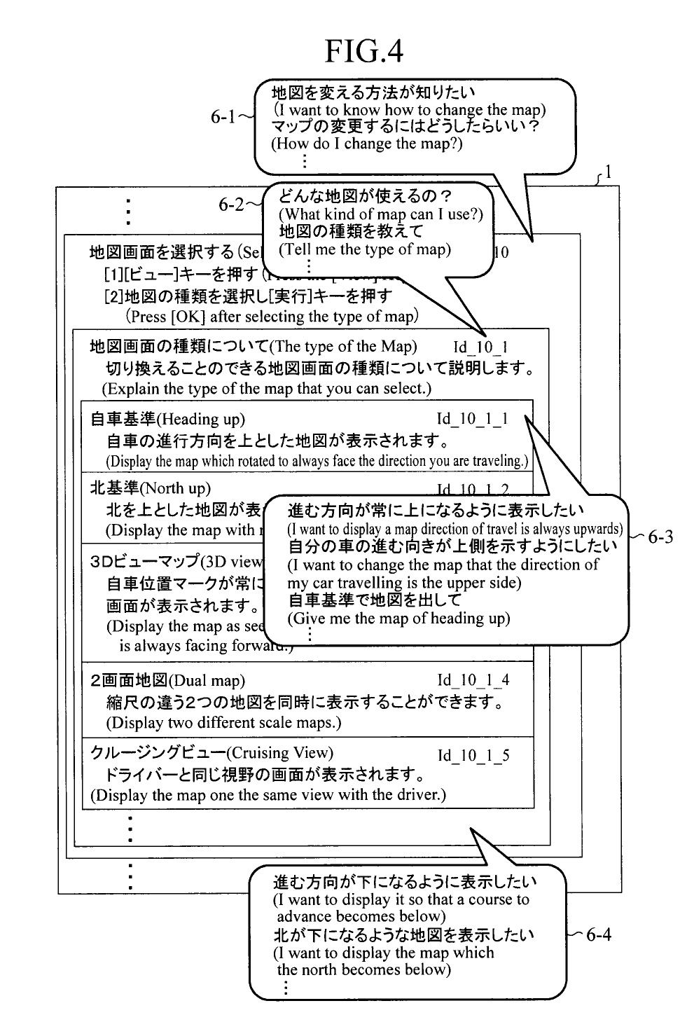

FIG. 4 shows an example of the collected utterance data 6. Collected utterance data 6-1 is an example of a question corresponding to a document of “Id_{—}10”, collected utterance data 6-2 is an example of a question corresponding to a document of “Id_{—}10_{—}1”, and collected utterance data 6-3 is an example of a question corresponding to a document of “Id_{—}10_{—}1_{—}1.” Although collected utterance data 6-4 is a question expressing an intention to desire to know a concrete changing method of changing the type of map, the collected utterance data is an example of collected utterance data which makes it impossible to select any document ID in the same hierarchical layer as “Id_{—}10 _{—}1_{—}1” because the map type which the user desires cannot be provided by the product which is assumed in this embodiment. These collected utterance data 6-1 to 6-4 are examples of question sentences which are generated by expecting what question the user asks in order to check the functions of the product.

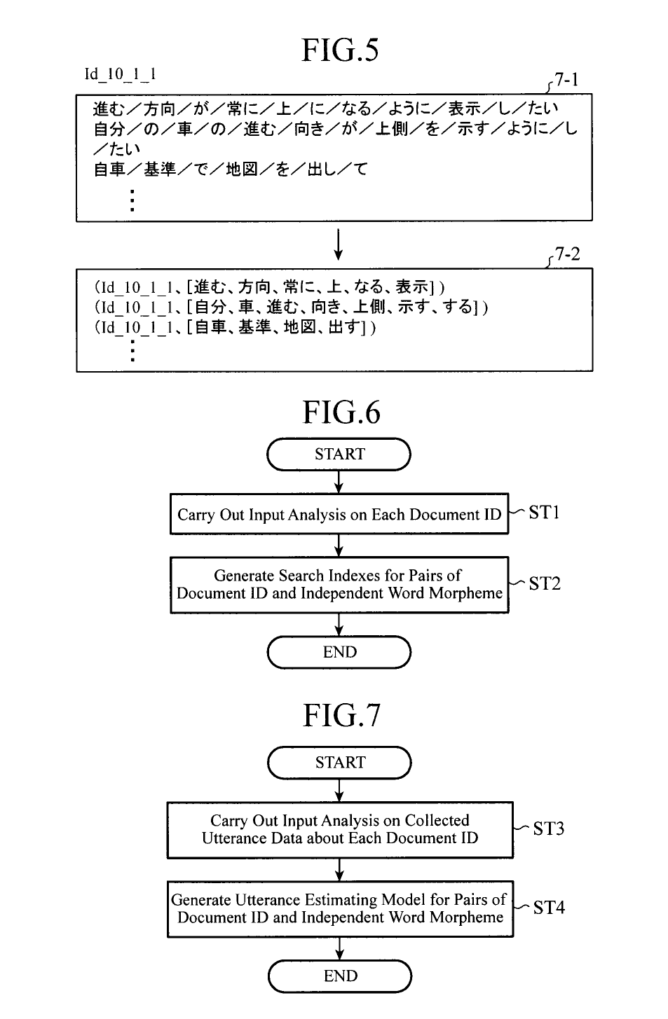

FIG. 5 shows an example of the collected utterance analysis results 7 and a keyword list for the utterance estimating model 9. “Id_{—}10_{—}1_{—}1” is an example of collected utterance analysis results 7-1, and shows the results of carrying out an input analysis according to a morphological analysis on the text of the collected utterance data 6-1 of “Id_{—}10_{—}1_{—}1” shown in FIG. 4. Data 7-2 for utterance estimating model shows an example of data which is based on the collected utterance analysis results 7-1 of “Id_{—}10_{—}1_{—}1” and which the utterance estimating model generator 8 uses. In this embodiment, the document ID and a list of general forms (keywords) of independent word morphemes are extracted.

Next, the operation of the document search device will be explained. The operation is roughly divided into two processes. One of the processes is a generating process of generating search indexes 5 and an utterance estimating model 9 from the document 1 and the collected utterance data 6, respectively, and the other one is a search process of generating final search results 17 in response to a user input 10. First, the generating process will be explained.

First, a generating method of generating search indexes 5 in the generating process will be explained. Hereafter, it is assumed that weighting according to tf-idf, which is disclosed by a conventional technology, is carried out. FIG. 6 is a flow chart showing an operation including up to the process of generating search indexes 5 from the document 1. As shown in FIG. 2, it is assumed that the document 1 includes pairs in each of which a document ID is associated with a text. For example, in the document 1-2, the name of the document ID “Id_{—}10_{—}1_{—}1” is associated with a text “Heading up. Display the map which rotated to always face the direction you are traveling.” In step ST1, the input analyzer 2 reads the document 1 having this structure in turn, and carries out a morphological analysis which is a known technology on the document so as to divide the document into morpheme strings. The results of carrying out a morphological analysis on the document 1-2 are the document analysis results 3-1 shown in FIG. 3. Although only separators “/” for separating the morphemes are shown in these document analysis results 3-1, the document analysis results actually include pieces of part of speech information, the prototypes of conjugated words, and readings.

After document analysis results 3 are generated for each of all the document IDs, the search index generator 4, in next step ST2, extracts morphemes (keywords) required for the generation of search indexes 5 from all the document analysis results 3, generates pairs of (a document ID and a keyword list), and generates search indexes 5 on each of which weighting using tf-idf is carried out on the basis of all the pairs. The pair (a document ID and a keyword list) extracted from the document analysis results 3-1 shown in FIG. 3 is shown by data 3-2 for search indexes which is also shown in FIG. 3.

Although no explanation is made as to a concrete procedure for generating search indexes, this procedure will be explained briefly. First, tf-idf is carried out in such a way that the number of keywords included in all the document IDs is defined as the dimension of a vector, the keywords are assigned to the components of the vector respectively, and the value of the vector is expressed by a frequency (this process corresponds to tf). Further, weighting is carried out on this vector value in such a way that the vector value conforms to heuristics “keywords (general terms) appearing in many documents have a low degree of importance, while keywords appearing only in a specific document have a high degree of importance” (this process corresponds to idf). This table with weights serves as the search indexes 5.

Next, the generating process of generating an utterance estimating model 9 will be explained. FIG. 7 is a flow chart showing an operation including up to the process of generating an utterance estimating model 9 from the collected utterance data 6. The collected utterance data 6 are data in which utterances collected in advance from the user are assigned to the document IDs of documents which are answers to the utterances, respectively, as shown as the collected utterance data 6-1 to 6-4 in FIG. 4. According to the generating method of generating the collected utterance data 6, the data are generated by presenting a description explaining the function of each document ID by using a questionnaire or the like, and collecting a document showing what the user said in order to search for the function. For example, it can be expected that an utterance like the collected utterance data 6-3 can be collected when the concrete description “Heading up. Display the map which rotated to always face the direction you are traveling.” of “Id_{—}10_{—}1_{—}1” shown in FIG. 4 is presented to the user. On the other hand, it can be expected that collected utterance data starting from the collected utterance data 6-1 and also including the collected utterance data 6-2 to 6-4 can be collected when a superordinate concept, such as a document of “Id_{—}10”, is presented to the user. The collected utterance data 6-4 is utterance data about a description other than the functions of the product described in the document 1. In this case, the collected utterance data 6-4 is assigned to an intermediate document ID of “Id_{—}10_{—}1.” The above-mentioned operations are performed in advance by using manpower, and the data having the structure shown in FIG. 4 are prepared.

The input analyzer 2, in step ST3, carries out a morphological analysis on the collected utterance data 6, like in the case of receiving, as an input, the document 1 in step ST1. For example, the results of carrying out a morphological analysis on the collected utterance data 6-3 shown in FIG. 4 are the collected utterance analysis results 7-1 shown in FIG. 5. The utterance estimating model generator 8, in next step ST4, carries out a process of extracting a document ID and a list of keywords as the data 7-2 for utterance estimating model so as to generate an utterance estimating model 9, like in the case of step ST2. It is assumed in this embodiment that for the utterance estimating model 9, learning is carried out by using a maximum entropy method (referred to as an ME method from here on).

Although no detailed explanation of the ME method will be made hereafter, the ME method will be explained briefly. The ME method is the one of defining a pair of (a document ID and a keyword list) as learning data, and, when receiving a list of keywords as an input, estimating a document ID corresponding to the list. A weight for each pair of (a document ID and a keyword list) is calculated in such a way that the probability of occurrence is the highest (the number of correct answers increases) in the data which has been learned when estimating a document ID from the list of keywords, and the utterance estimating model 9 is the one in which the weight is stored. Keywords are extracted from all the collected utterance analysis results 7, and learning is carried out by using the ME method so as to generate the utterance estimating model 9. Concretely, for the collected utterance analysis results 7-1 shown in FIG. 5, the data 7-2 for utterance estimating model which is also shown in FIG. 5 is extracted, and the above-mentioned learning is carried out on the basis of this data 7-2 for utterance estimating model.

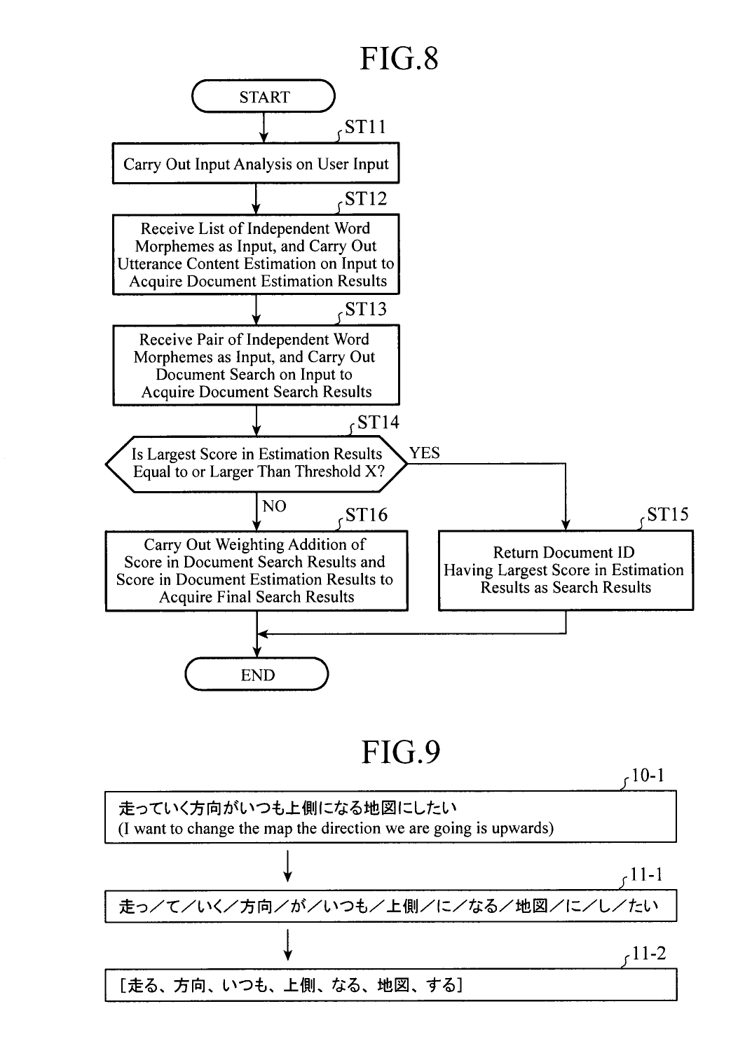

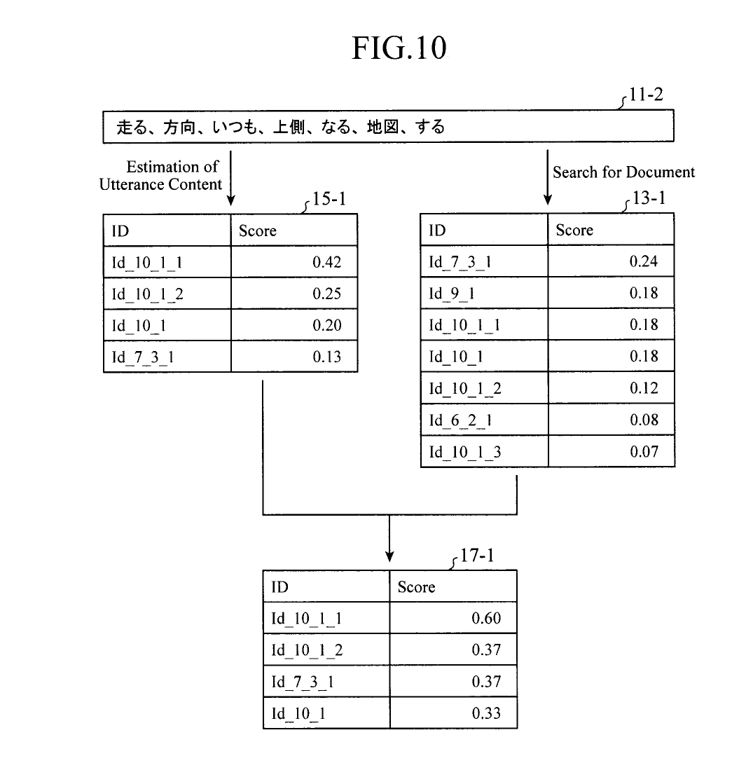

Next, the search process will be explained. FIG. 8 is a flow chart showing an operation including up to the process of generating final search results 17 from the user input 10. FIGS. 9 and 10 are views showing an example of a transition in the search process on a user input 10-1 which is an example of the user input 10. Hereafter, it is assumed that the user input 10 is an input of a text, and an explanation will be made assuming that the user input 10-1 shown in FIG. 9 is inputted. The input analyzer 2, in step ST11, receives the user input 10-1 and carries out a morphological analysis on the user input first so as to generate user input analysis results 11-1, and extracts independent words from the user input analysis results 11-1 so as to generate a keyword list 11-2. The utterance content estimator 14, in next step ST12, uses this keyword list 11-2 as an input, and acquires document estimation results 15-1 as shown in FIG. 10 from the utterance estimating model 9. As shown in FIG. 10, the document estimation results 15-1 are arranged in a line in the order of their scores. These scores are values calculated from the weights of the pairs each consisting of (a document ID and a keyword list) which are stored in the utterance estimating model 9, and a higher score is assigned to a document ID having a higher degree of association with the user input 10, i.e., a document ID more suitable as an answer to the question of the user input 10.

After the document estimation results 15-1 are acquired, the document searcher 12, in next step ST13, uses the keyword list 11-2 as an input this time and acquires document search results 13-1 shown in FIG. 10 from the search indexes 5. As shown in FIG. 10, the document search results 13-1 are also arranged in a line in the order of their scores. These scores are values calculated from the weights of tf-idf stored in the search indexes 5, and a higher score is assigned to a document ID having a higher degree of association with the user input 10. Because a known technique can be used as a calculating method of calculating the scores in the document estimation results 15 and the scores in the document search results 13, the explanation of the calculating method will be omitted hereafter.

After completing the process of step ST13, the document search device then shifts to a process of step ST14 and the result integrator 16 judges whether or not the largest score in the document estimation results 15-1 is equal to or larger than a threshold X (e.g., X=0.9) determined in this step. Because the largest score in the document estimation results 15-1 is smaller than the threshold X (when “NO” in step ST14), the result integrator 16 advances to a process of step ST16. The result integrator, in step ST16, carries out a weighting addition on each score in the document search results 13-1 and the corresponding score in the document estimation results 15-1 for each document ID so as to generate final search results 17-1. Referring to FIG. 10, the results of carrying out the addition with (each score in the document estimation results 15-1): (the corresponding score in the document search results 13-1)=1:1 are the final search results 74.

In contrast, when, in step ST14, the largest score in the document estimation results 15-1 exceeds the threshold X (when “YES” in step ST14), the result integrator 16, in next step ST15, discards the document search results 13-1 and determines the document estimation results 15-1 as the final search results (not shown). After completing the search, the document search device displays the titles or the like of the document IDs on the screen so as to enable the user to select one of them, thereby presenting his or her desired document position to the user.

As mentioned above, the document search device in accordance with Embodiment 1 includes: the search indexes 5 generated from the document 1 which is prepared in advance; the document searcher 12 that receives the user input analysis results 11 which are acquired by analyzing the user input 10, and searches through the document 1 for document IDs associated with the user input analysis results 11 by using the search indexes 5; the utterance estimating model 9 that is generated by learning the collected utterance data 6 in which a correspondence between hypothetical questions (user utterances) each as to a content of the document 1 and document IDs each of which is an answer to one of the hypothetical questions; the utterance content estimator 14 that estimates a document ID corresponding to an answer to the user input analysis results 11 from the document 1 on the basis of the utterance estimating model 9; and the result integrator 16 that integrates document search results 13 acquired from the document searcher 12 and document estimation results 15 acquired from the utterance content estimator 14 so as to generate final search results 17. Therefore, the document search device carries out utterance content estimation based on the collected utterance data 6, which is different from a simple document search function, thereby being able to perform a search, which cannot be implemented by a conventional document search function, using either of an expression and a general term which is inputted by either of a general user and an entry level user and which does not appear in the document 1. Therefore, search results more suitable as compared with results acquired by using a simple search method can be presented in response to a user input in natural language.

Further, in accordance with Embodiment 1, the utterance content estimator 14 adds a score according to the degree of association with the user input 10 to each estimated document ID, and, when the score in the document estimation results 15 acquired from the utterance content estimator 14 is larger than the predetermined threshold X, the result integrator 16 neglects the document search results 13 acquired from the document searcher 12 so as to generate final search results 17. Therefore, when the input is made by either of a general user and an entry level user and is either of an expression and a general term which do not appear in the document 1, the document search device can prevent the search results from including many unsuitable search result candidates, unlike in the case of using a simple search method, and can present more appropriate search results for the user input.

Although the document search device in accordance with Embodiment 1 is constructed in such a way as to, when the largest score in the document estimation results 15 is larger than the predetermined threshold X, determine the document estimation results 15 as final search results 17, just as they are, the document search device can alternatively carry out a weighting addition of each score in the document estimation results 15 and the corresponding score in the document search results 13 with a predetermined ratio from the beginning. While each score in the document estimation results 15 is calculated from the document estimated directly from the user's utterance, each score in the document search results 13 is calculated from the presence or absence of a keyword in the document . Accordingly, although each of the two methods has its merits and demerits, the document search device can present final search results having very good scores according to the two methods by carrying out a weighting addition on the scores provided by the two methods.

Further, the document search device in accordance with Embodiment 1 includes: the input analyzer 2 that analyzes the document 1 prepared in advance and the collected utterance data 6 in which a correspondence between user utterances each questioning about a content of the document 1 and document IDs each of which is an answer to one of the user utterances is defined; the search index generator 4 that generates search indexes 5 from document analysis results 3 outputted from the input analyzer 2; and the utterance estimating model generator 8 that learns the correspondence between the user utterances and the document IDs by using the collected utterance analysis results 7 outputted from the input analyzer 2 so as to generate an utterance estimating model 9. Therefore, the document search device can perform a search, which cannot be implemented by a conventional document search function, using either of an expression and a general term which is inputted by either of a general user and an entry level user and which does not appear in the document 1.

### Embodiment 2

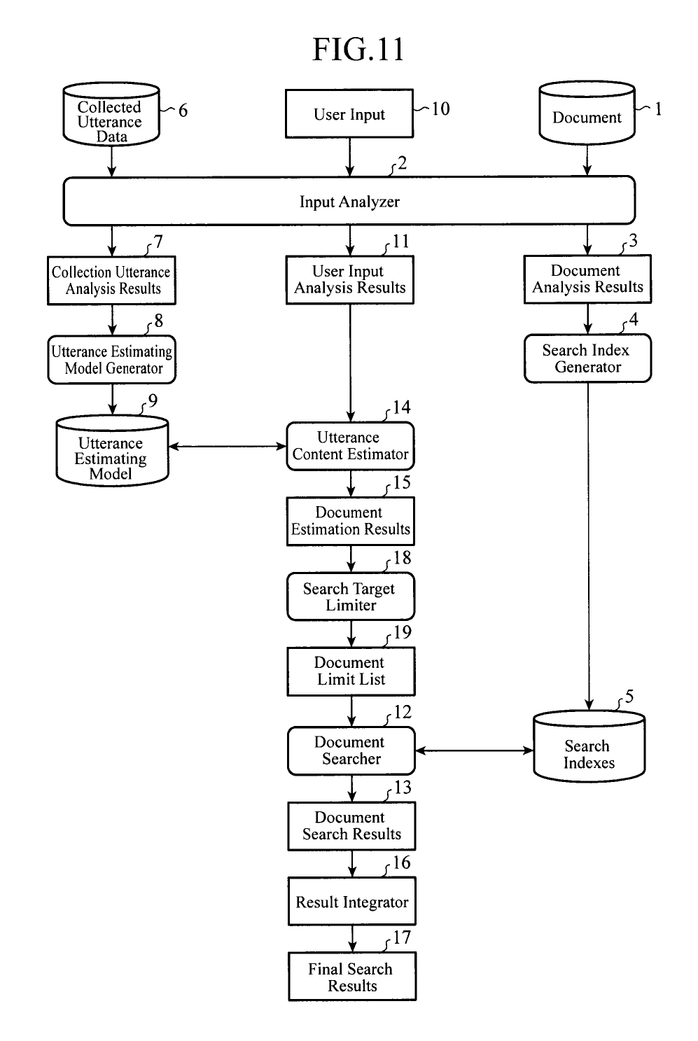

FIG. 11 is a block diagram showing the structure of a document search device in accordance with this Embodiment 2. In FIG. 11, the same components as those shown in FIG. 1 or like components are designated by the same reference numerals, and the explanation of the components will be omitted hereafter. A big difference between Embodiment 2 and above-mentioned Embodiment 1 is in the following two points.

(1) Generate an utterance estimating model 9 in which collected utterance data 6 are assigned to document IDs of larger units, instead of fines unit, respectively.

(2) Use document estimation results 15 in order to limit the search range using search indexes 5.

Referring to FIG. 11, a search target limiter 18 limits the search target of a document searcher 12 to lower layer document IDs of document estimation results 15. A document limit list 19 holds limited document IDs.

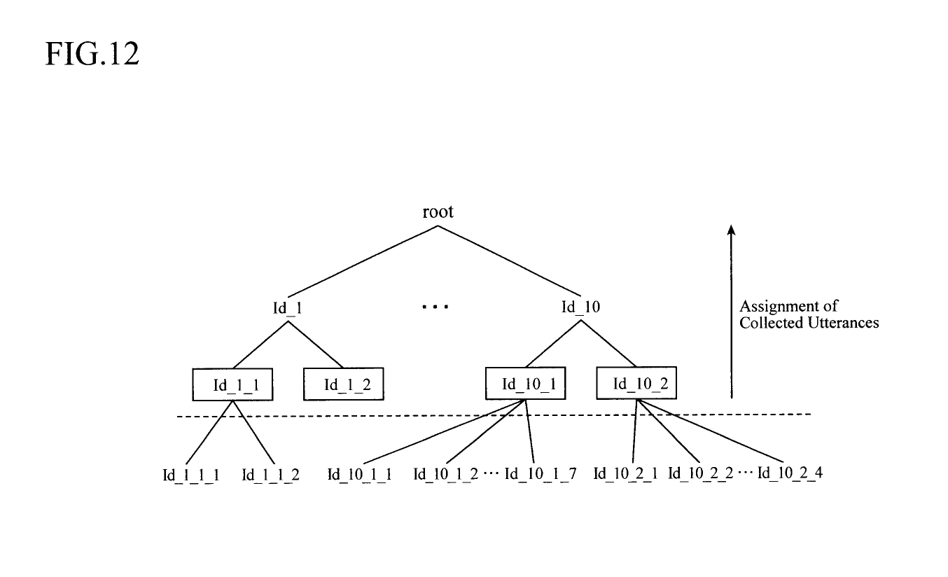

FIG. 12 is a view showing the hierarchical layers of document IDs of a document 1. The example of FIG. 12 shows that collected utterance data 6 are assigned to document IDs in a first hierarchical layer and document IDs in a second hierarchical layer without the collected utterance data 6 being assigned to document IDs in layers lower than the second hierarchical layer (document IDs each enclosed by a square).

Next, the operation of the document search device will be explained. An operation in the generating process is fundamentally the same as that in accordance with above-mentioned Embodiment 1. However, as shown in FIG. 12, it is assumed that the assignment of the collected utterance data 6 to document IDs is limited to the hierarchical layers at the same level as or higher than the second hierarchical layer. Therefore, in the example shown in FIG. 4, the collected utterance data 6-1 is assigned to a document ID of “Id_{—}10”, and the other collected utterance data 6-2 to 6-4 are all assigned to a document ID of “Id_{—}10_{—}1.”

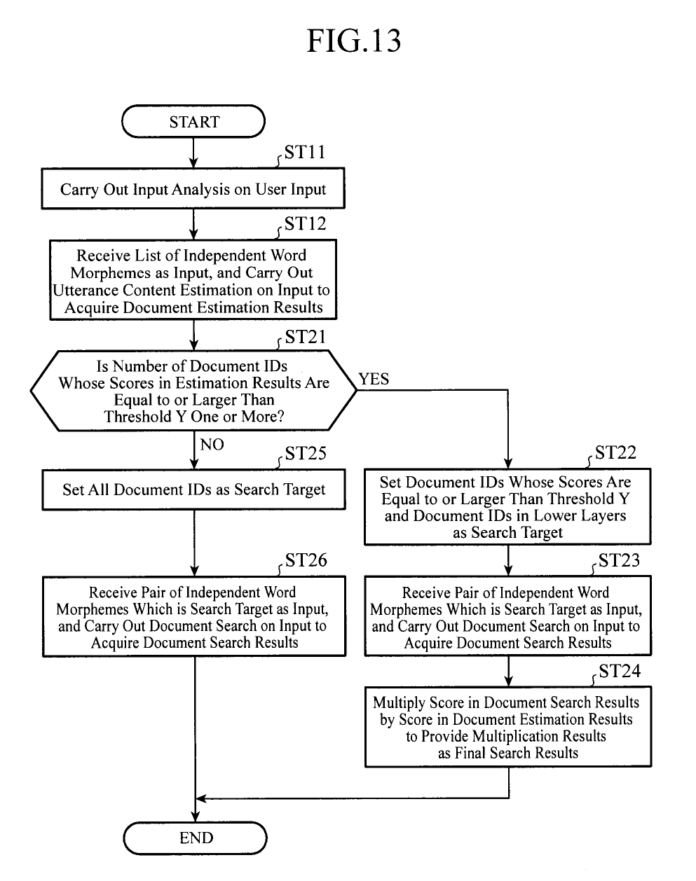

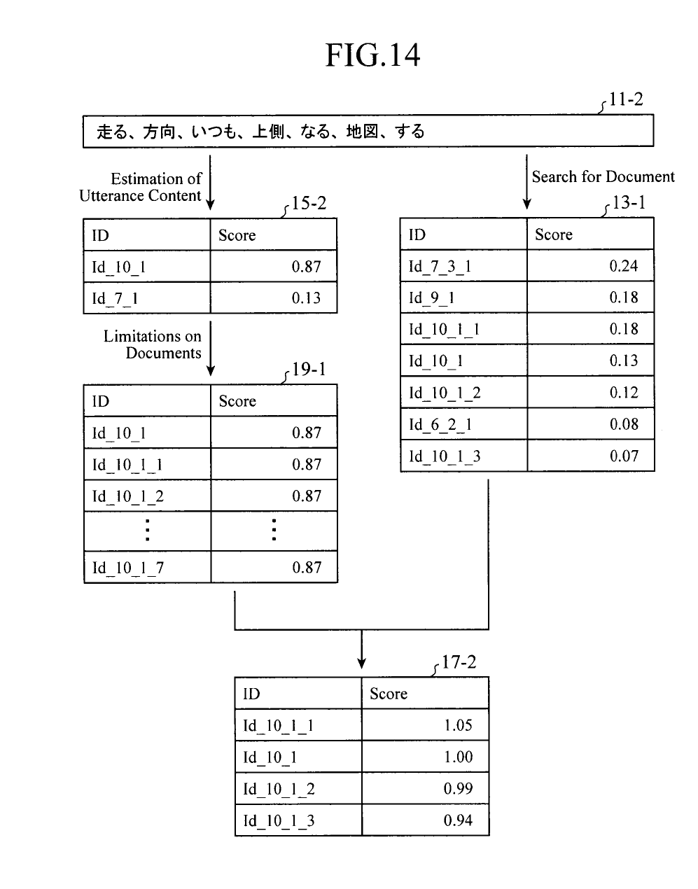

Next, a search process will be explained. FIG. 13 is a flow chart showing an operation including up to a process of generating final search results 17 from a user input 10. FIG. 14 is a view explaining the operation of the search target limiter 18. Like in the case of above-mentioned Embodiment 1, an explanation will be made assuming that the user input 10 is an input of a text and a user input 10-1 shown in FIG. 9 is inputted. An input analyzer 2, in step ST11, analyzes the user input 10-1, like in the case shown in FIG. 8. Next, an utterance content estimator 14, in step ST12, carries out utterance content estimation. As the results of the estimation, document estimation results 15-2 (document IDs and scores) shown in FIG. 14 are provided. Because the assignment of the collected utterance data 6 to document IDs is limited to the hierarchical layers at the same level as or higher than the second hierarchical layer, as mentioned above, there are no document IDs of hierarchical layers at the same level as or lower than the third hierarchical layer.

The search target limiter 18, in next step ST21, checks whether one or more document IDs whose scores in the document estimation results 15-2 are equal to or larger than a threshold Y (e.g., Y=0.6) exist. Because the score of “ID_{—}10_{—}1” is equal to or larger than 0.6 in the document estimation results 15-2 (when “YES” in step ST21) , the search target limiter shifts the process to step ST22, expands the document ID whose score is equal to or larger than the threshold Y into document IDs in lower hierarchical layers, and adds the same score to each of the expanded document IDs. Further, because only “Id_{—}10_{—}1” has a score equal to or larger than the threshold Y in the document estimation results 15-2, the search target limiter 18 selects the document IDs of “Id_{—}10_{—}1_{—}1” to “Id_{—}10_{—}1_{—}7” in the layers lower than that of “Id_{—}10_{—}1” as a search target, and sets the document IDs as a document limit list 19-1.

The document searcher 12, in next step ST23, searches through the search indexes 5 by using a keyword list 11-2 shown in FIG. 14, and acquires document search results 13-1. The document searcher then, in step ST24, outputs the results of multiplying each score in these document search results 13-1 by the corresponding score in the document limit list 19-1 as final search results 17-2.

In contrast, when, in step ST21, no score exceeding the threshold Y exists in the document estimation results 15-2 (when “NO” in step ST21), the search target limiter 18 discards these document estimation results 15-2 (step ST25), and the document searcher 12, in next step ST26, acquires document search results (not shown) with all the document IDs being determined as the search target, and outputs the document search results as final search results (not shown), just as they are.

As mentioned above, the document search device in accordance with Embodiment 2 is constructed in such a way that the document search device includes the search target limiter 18 that extracts a document ID whose score is equal to or larger than the predetermined threshold Y and another document ID in a lower layer than that of the document ID from the document estimation results 15 acquired from the utterance content estimator 14, the utterance content estimator 14 carries out estimation on the basis of an utterance estimating model that has learned a correspondence between document IDs in higher hierarchical layers than a hierarchical layer which is the smallest unit for search using the search indexes 5, and the collected utterance data 6, and the result integrator 16 integrates a document ID included in the document estimation results acquired from the utterance content estimator 14 and extracted by the search target limiter 18 with the document search results 13 acquired from the document searcher 12. Therefore, by assigning the collected utterance data 6 to the document IDs in the higher hierarchical layers, mapping the collected utterance data 6 to document IDs which does not have to take into consideration a small difference in functions between the models of the product can be implemented. Therefore, mapping between document IDs and the collected utterance data 6 can be facilitated and a reduction in the accuracy of search due to data sparseness can be prevented. Further, because the functions of the product can be defined at a general-purpose level, the document search device can use the collected utterance data 6 in common also in the development of products having many models, and can easily deal with new products.

Although in above-mentioned Embodiments 1 and 2 the explanation is made by using search indexes compliant with the statistical search method as the search indexes 5, a probability can be set up by using search indexes compliant with a boolean search method on the basis of the total sum of the numbers of appearances of search keywords. In this case, there can be considered a method of expressing a maximum of the sum total of the numbers of appearances of search keywords as N, and defining the result of dividing the sum total of the numbers of appearances of search keywords in each document by N as a score, and a method of expressing the sum total of N of all the documents in the search results as M, and defining the result of dividing the sum total of the numbers of appearances of search keywords in each document by N as a score.

In addition, although the example of defining an independent word as each unit for the generation of the search indexes 5 and each unit for the generation of the utterance estimating model 9 is shown in above-mentioned Embodiments 1 and 2, the search index 5 and the utterance estimating model 9 can be alternatively generated by defining a unit, such as a phoneme n-gram or a syllable n-gram as each unit for the generation of the search indexes 5 and each unit for the generation of the utterance estimating model 9. As an alternative, the search index 5 and the utterance estimating model 9 can be generated by combining a high-frequency appearance word and a phoneme n-gram, or a high frequent appearance word and a syllable n-gram. In this case, the size of the search indexes 5 and the size of the utterance estimating model 9 can be reduced.

Further, in above-mentioned Embodiments 1 and 2, a special document ID can be added to an utterance, such as the collected utterance data 6-4 shown in FIG. 4, which cannot be assigned to any portion of the document 1 because no corresponding product function exists and hence no appropriate description exists in the document, so as to generate an utterance estimating model 9, and, when the document ID having the largest score in the document estimation results 15 for the user input 10 is the special document ID, the result integrator 16 can generate final search results 17 without using the document search results 13. Further, in this case, the document search device can be constructed in such a way as to present a message corresponding to the special document ID.

In addition, although the case in which the user input 10 is a text input is explained as an example in above-mentioned Embodiments 1 and 2, voice recognition can be used as an input unit. In this case, there can be considered a method of processing a first candidate text in voice recognition results as the user input 10 and a method of processing first through Nth candidate texts in the voice recognition results as the user input 10. Further, in the case in which voice recognition results are generated per morpheme, the process by the input analyzer 2 can be omitted and the voice recognition results can be handled as the user input analysis results 11, just as they are.

Further, although the example of an input in Japanese is explained in above-mentioned Embodiments 1 and 2, the language is not limited to Japanese. The present invention can be applied to an input in another language, such as English, German, or Chinese, and the same effect can be produced by changing the input analyzer 2 according to the language.

### Embodiment 3

Hereafter, an example of an input in English will be explained. Because a document search device in accordance with this Embodiment 3 has the same structure as the document search device shown in FIG. 1 from a graphical viewpoint, the document search device in accordance with this embodiment will be explained hereafter by using FIG. 1.

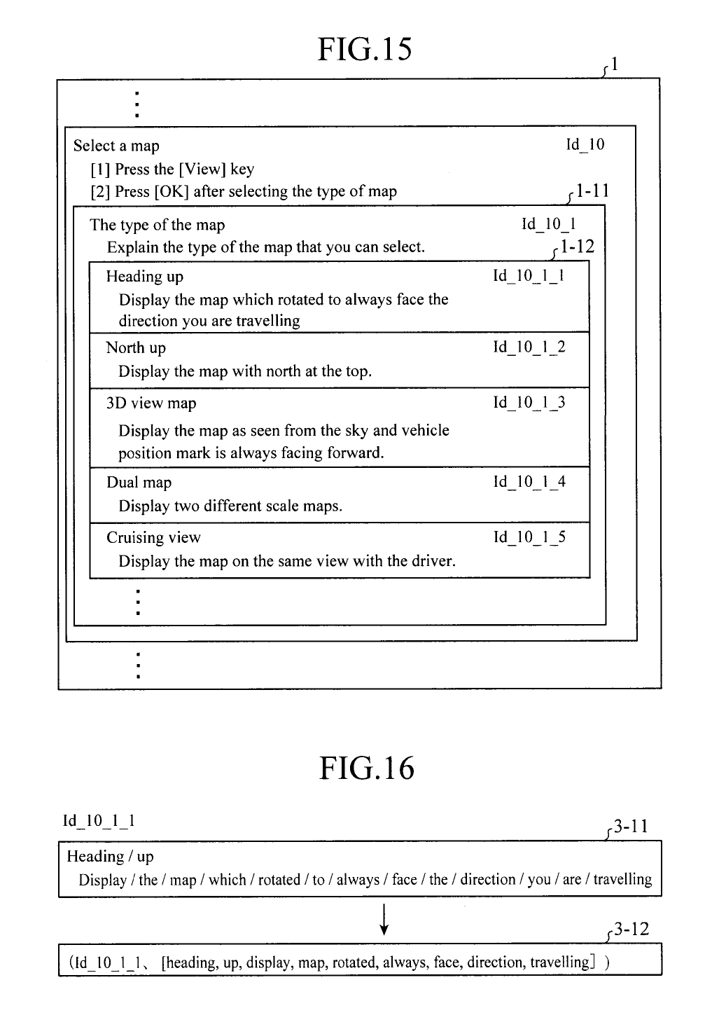

FIG. 15 shows an example of an English document 1 inputted to the document search device in accordance with this Embodiment 3. The document 1 has a structure of hierarchical layers, such as a chapter layer, a paragraph layer, and a section layer, and has a document ID showing a search result position for each hierarchical layer. In the example shown in FIG. 15, a document 1-11 having a document ID of “Id_{—}10_{—}1” also includes texts included in a lower layer data structure. For example, the figure shows that a document 1-12 of “Id_{—}10_{—}1_{—}1” is also included in the document 1-11 of “Id_{—}10_{—}1.”

FIG. 16 shows an example of document analysis results 3 and a keyword list for the search indexes 5. “Id_{—}10_{—}1_{—}1” is an example of document analysis results, and shows the results of carrying out an input analysis according to a morphological analysis on the document 1-12 of “Id_{—}10_{—}1_{—}1” shown in FIG. 15. Although only information in which the sections of the morphological analysis results are separated by “/” is shown in these document analysis results 3-11, information including part of speech information is also generated actually. Data 3-12 for search indexes shows an example of data which is generated on the basis of the document analysis results 3-11 of “Id_{—}10_{—}1_{—}1” and which a search index generator 4 uses. In this embodiment, document IDs and independent word morphemes except prepositions, articles, be verbs, and pronouns are extracted.

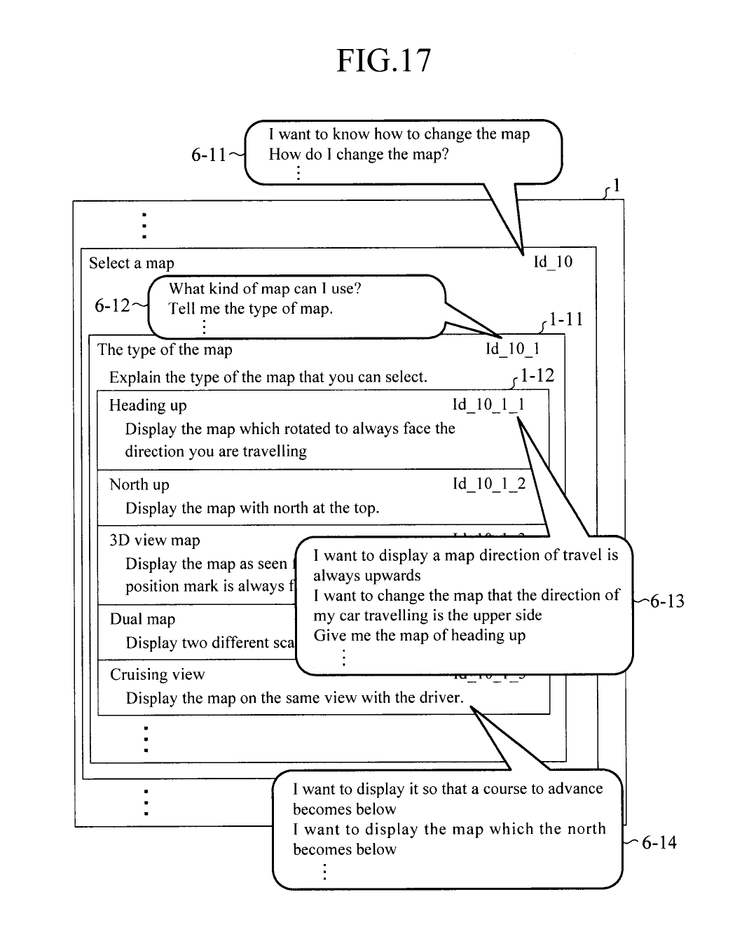

FIG. 17 shows an example of collected utterance data 6. Collected utterance data 6-11 is an example of a question corresponding to a document of “Id_{—}10”, collected utterance data 6-12 is an example of a question corresponding to a document of “Id_{—}10_{—}1”, and collected utterance data 6-13 is an example of a question corresponding to a document of “Id_{—}10_{—}1_{—}1.” Although collected utterance data 6-14 is a question expressing an intention to desire to know a concrete changing method of changing the type of map, the collected utterance data is an example of collected utterance data which makes it impossible to select any document ID in the same hierarchical layer as “Id_{—}10_{—}1_{—}1” because the map type which the user desires cannot be provided by the product which is assumed in this embodiment.

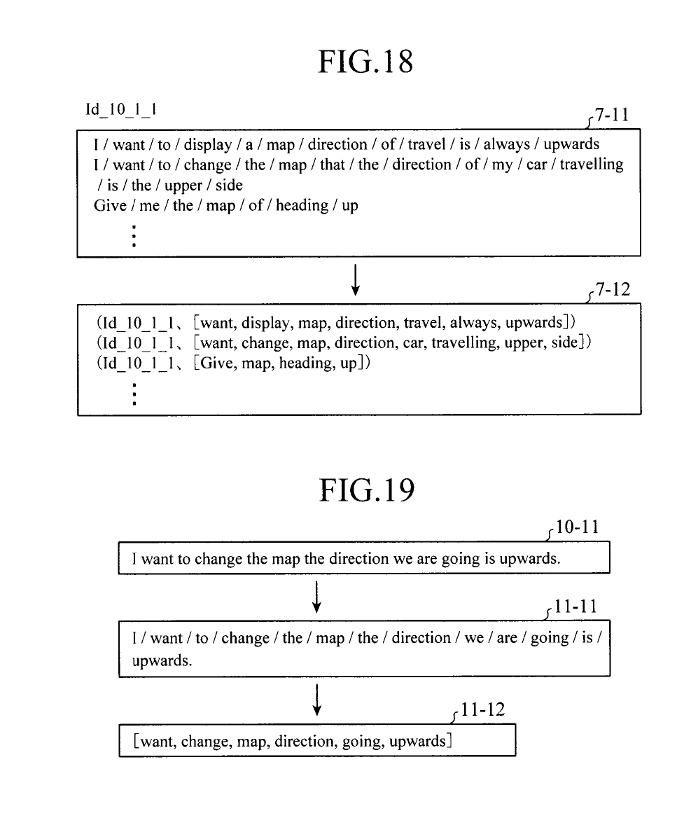

FIG. 18 shows an example of collected utterance analysis results 7 and a keyword list for an utterance estimating model 9. Collected utterance analysis results 7-11 of “Id_{—}10_{—}1_{—}1” are an example of the collected utterance analysis results of the collected utterance data 6-13 of “Id_{—}10_{—}1_{—}1” shown in FIG. 17, and data 7-12 for utterance estimating model shows an example of data which is based on the collected utterance analysis results 7-11 of “Id_10_1_1” and which an utterance estimating model generator 8 uses. In this embodiment, document IDs and independent word morphemes except prepositions, articles, and be verbs are extracted.

Next, the operation of the document search device will be explained. The operation of the document search device in accordance with this Embodiment 3 (a generating process and a search process) is fundamentally the same as that shown in FIGS. 6 to 8 in accordance with above-mentioned Embodiment 1. Therefore, only a different portion will be explained hereafter. First, the generating process will be explained.

First, a generating method of generating search indexes 5 in the generating process will be explained. Hereafter, it is assumed that weighting according to tf-idf, which is disclosed by a conventional technology, is carried out. As shown in FIG. 15, it is assumed that the document 1 includes pairs in each of which a document ID is associated with a text. For example, in a document 1-2, the name of the document ID “Id_{—}10_{—}1_{—}1” is associated with a text “Heading up. Display the map which rotated to always face the direction you are travelling.” In step ST1 of FIG. 6, an input analyzer 2 reads the document 1 having this structure in turn, and carries out a morphological analysis which is a known technology on the document so as to divide the document into morpheme strings. The results of carrying out a morphological analysis on the document 1-2 are the document analysis results 3-11 shown in FIG. 16. Although only separators for separating the morphemes are shown in these document analysis results 3-11, the document analysis results actually include pieces of part of speech information, and the prototypes of conjugated words.

After document analysis results 3 are generated for each of all the document IDs, the search index generator 4, in next step ST2, extracts morphemes (keywords) required for the generation of search indexes 5 from all the document analysis results 3, generates pairs of (a document ID and a keyword list), and generates search indexes 5 on each of which weighting using tf-idf is carried out on the basis of all the pairs. The pair (a document ID and a keyword list) extracted from the document analysis results 3-11 shown in FIG. 16 is shown by data 3-12 for search indexes which is also shown in FIG. 16.

Because a concrete procedure for generating search indexes is the same as that in accordance with above-mentioned Embodiment 1, the explanation of the generating procedure will be omitted hereafter.

Next, the generating process of generating an utterance estimating model 9 will be explained. The collected utterance data 6 are data in which utterances collected in advance from the user are assigned to the document IDs of documents which are answers to the utterances, respectively, as shown as the collected utterance data 6-11 to 6-14 in FIG. 17. Because the generating method of generating the collected utterance data 6 is the same as that in accordance with above-mentioned Embodiment 1, the explanation of the generating method will be omitted hereafter.

The input analyzer 2, in step ST3 shown in FIG. 7, carries out a morphological analysis on the collected utterance data 6, like in the case of receiving, as an input, the document 1 in step ST1 previously explained. For example, the results of carrying out a morphological analysis on the collected utterance data 6-13 shown in FIG. 17 are the collected utterance analysis results 7-11 shown in FIG. 18. The utterance estimating model generator 8, in next step ST4, extracts a document ID and a list of keywords as the data 7-12 for utterance estimating model, like in the case of step ST2 previously explained, and carries out learning for the utterance estimating model 9 by using an ME method, like in the case of above-mentioned Embodiment 1. Keywords are extracted from all the collected utterance analysis results 7, and learning is carried out by using the ME method so as to generate the utterance estimating model 9. Concretely, for the collected utterance analysis results 7-11 shown in FIG. 18, the data 7-12 for utterance estimating model which is also shown in FIG. 18 is extracted, and the above-mentioned learning is carried out on the basis of this data 7-12 for utterance estimating model.

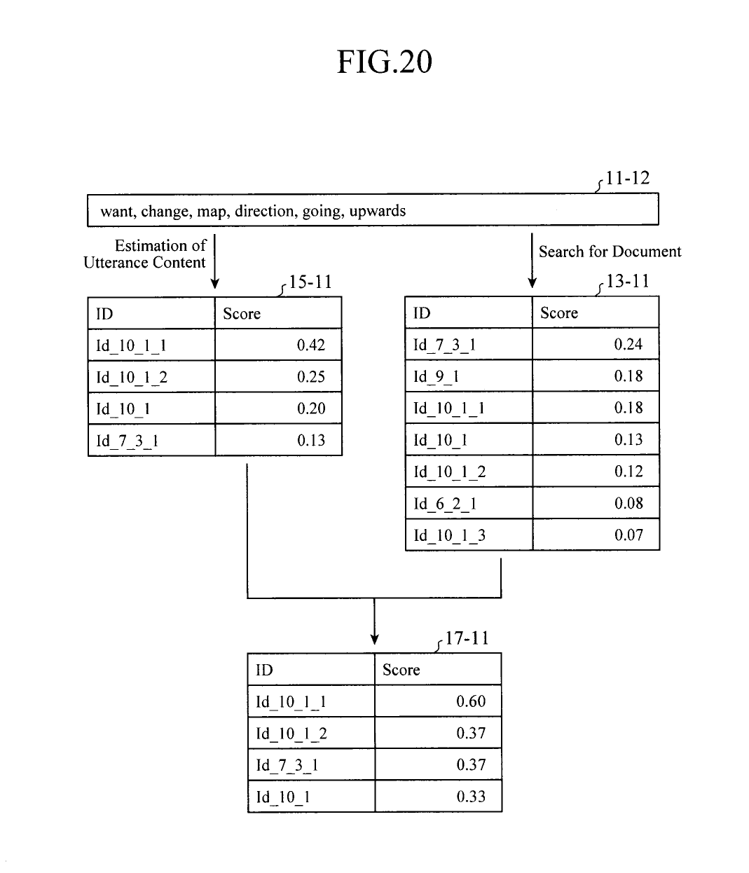

Next, the search process will be explained. FIGS. 19 and 20 are views showing an example of a transition in the search process on a user input 10-11 which is an example of the user input 10. Hereafter, it is assumed that the user input 10 is an input of a text, and an explanation will be made assuming that the user input 10-11 shown in FIG. 19 is inputted. The input analyzer 2, in step ST11 shown in FIG. 8, receives the user input 10-11 and carries out a morphological analysis on the user input first so as to generate user input analysis results 11-11, and extracts independent words excluding prepositions, articles, be verbs, and pronouns from the user input analysis results 11-11 so as to generate a keyword list 11-12. An utterance content estimator 14, in next step ST12, uses this keyword list 11-12 as an input, and acquires document estimation results 15-11 as shown in FIG. 20 from the utterance estimating model 9. As shown in FIG. 20, the document estimation results 15-11 are arranged in a line in the order of their scores.

After the document estimation results 15-11 are acquired, a document searcher 12, in next step ST13, uses the keyword list 11-12 as an input this time and acquires document search results 13-11 shown in FIG. 20 from the search indexes 5. As shown in FIG. 20, the document search results 13-11 are also arranged in a line in the order of their scores.

A result integrator 16, in next step ST14, judges whether or not the largest score in the document estimation results 15-11 is equal to or larger than a threshold X (e.g., X=0.9) determined in this step. Because the largest score in the document estimation results 15-11 is smaller than the threshold X (when “NO” in step ST14), the result integrator 16 advances to a process of step ST16. The result integrator, in step ST16, carries out a weighting addition on each score in the document search results 13-11 and the corresponding score in the document estimation results 15-11 for each document ID so as to generate final search results 17-11. Referring to FIG. 20, the results of carrying out the addition with (each score in the document estimation results 15-11): (the corresponding score in the document search results 13-11)=1:1 are the final search results 17-11.

In contrast, when, in step ST14, the largest score in the document estimation results 15-11 exceeds the threshold X (when “YES” in step ST14), the result integrator 16, in next step ST15, discards the document search results 13-11 and determines the document estimation results 15-11 as the final search results (not shown) . After completing the search, the document search device displays the titles or the like of the document IDs on the screen so as to enable the user to select one of them, thereby presenting his or her desired document position to the user.

As mentioned above, the document search device in accordance with Embodiment 3 can carry out the same processes as those in accordance with above-mentioned Embodiment 1 not only on a Japanese document but also an English document 1, and can provide the same advantages as those provided by above-mentioned Embodiment 1 also when receiving an English input. Although an explanation will be omitted hereafter, the structure in accordance with Embodiment 3 can be applied to above-mentioned Embodiment 2.

### Embodiment 4

Hereafter, an example of an input expressed in Chinese will be explained. Because a document search device in accordance with this Embodiment 4 has the same structure as the document search device shown in FIG. 1 from a graphical viewpoint, the document search device in accordance with this embodiment will be explained hereafter by using FIG. 1.

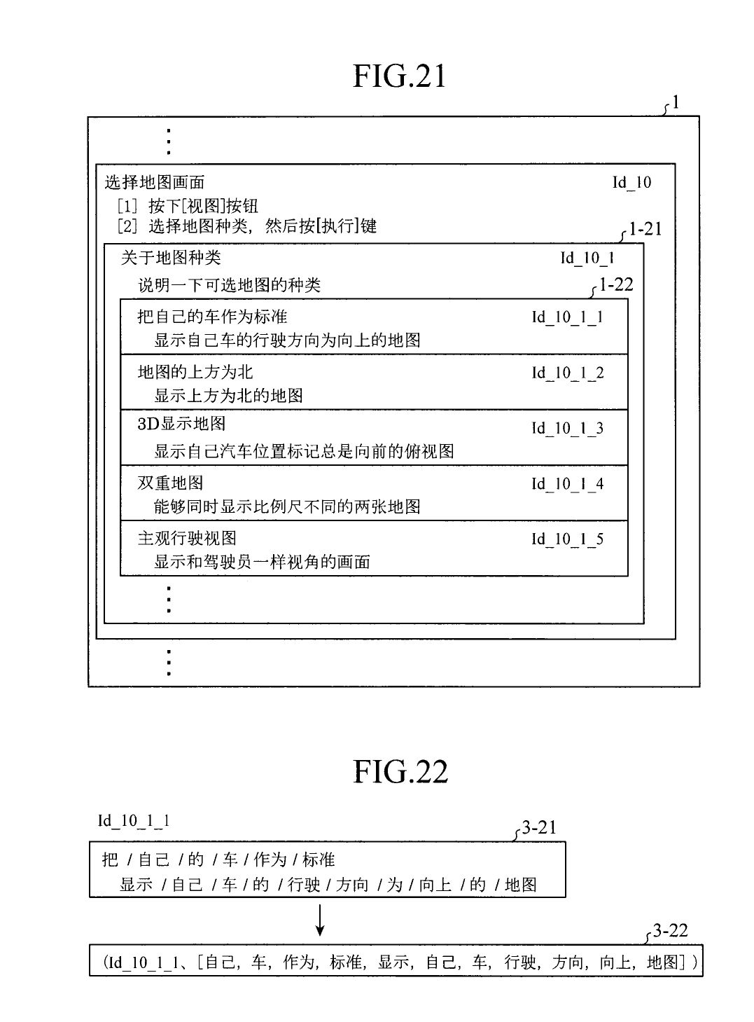

FIG. 21 shows an example of a Chinese document 1 inputted to the document search device in accordance with this Embodiment 4. The document 1 has a structure of hierarchical layers, such as a chapter layer, a paragraph layer, and a section layer, and has a document ID showing a search result position for each hierarchical layer. In the example shown in FIG. 21, a document 1-21 having a document ID of “Id_{—}10_{—}1” also includes texts included in a lower layer data structure. For example, the figure shows that a document 1-22 of “Id_{—}10_{—}1_{—}1” is also included in the document 1-21 of “Id_{—}10_{—}1.”

FIG. 22 shows an example of document analysis results 3 and a keyword list for the search indexes 5. “Id_{—}10_{—}1_{—}1” is an example of document analysis results, and shows the results of carrying out an input analysis according to a morphological analysis on the document 1-22 of “Id_{—b 10}_{—}1_{—}1” shown in FIG. 21. Although only information in which the sections of the morphological analysis results are separated by “/” is shown in these document analysis results 3-21, information including part of speech information is also generated actually. Data 3-22 for search indexes shows an example of data which is generated on the basis of the document analysis results 3-22 of “Id_{—}10_{—}1_{—}” and which a search index generator 4 uses. In this embodiment, document IDs and independent word morphemes except pronouns, particles, and prepositions are extracted.

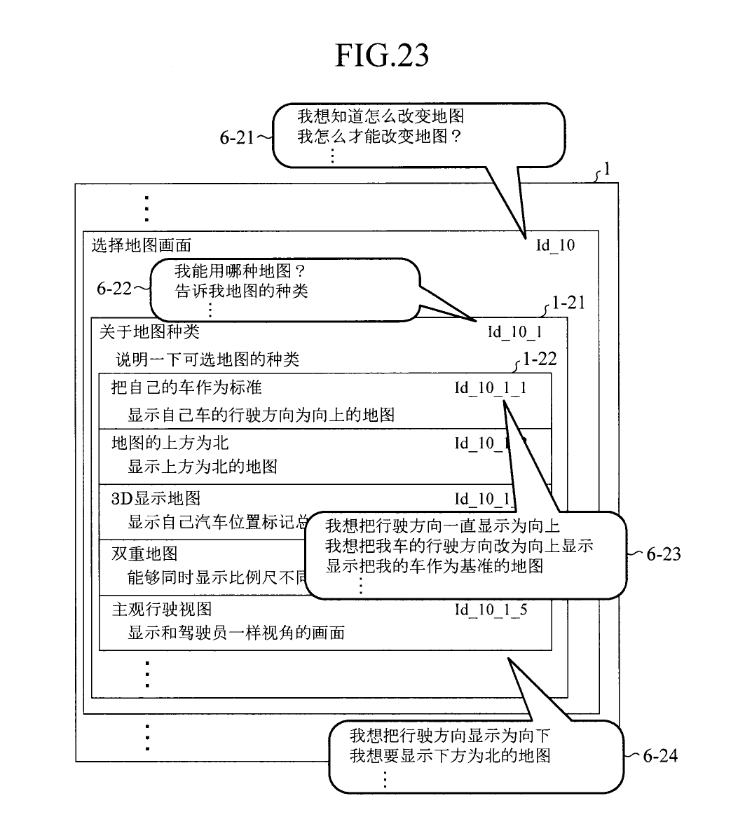

FIG. 23 is an example of collected utterance data 6. Collected utterance data 6-21 is an example of a question corresponding to a document of “Id_{—}10”, collected utterance data 6-22 is an example of a question corresponding to a document of “Id_{—}10_{—}1”, and collected utterance data 6-23 is an example of a question corresponding to a document of “Id_{—}10_{—}1_{—}1.” Although collected utterance data 6-24 is a question expressing an intention to desire to know a concrete changing method of changing the type of map, the collected utterance data is an example of collected utterance data which makes it impossible to select any document ID in the same hierarchical layer as “Id_{—}10_{—}1_{—}1” because the map type which the user desires cannot be provided by the product which is assumed in this embodiment.

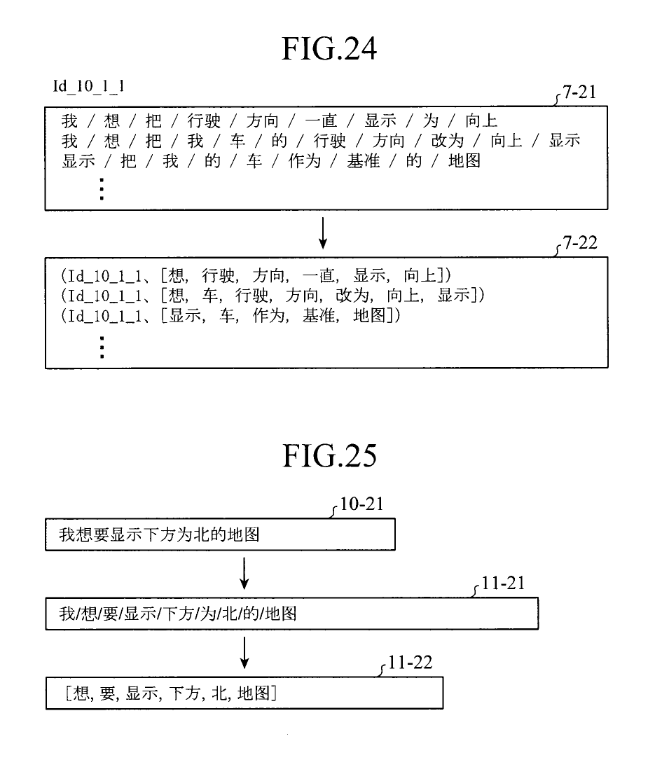

FIG. 24 shows an example of collected utterance analysis results 7 and a keyword list for an utterance estimating model 9. Collected utterance analysis results 7-21 of “Id_{—}10_{—}1_{—}1” are an example of the collected utterance analysis results of the collected utterance data 6-23 of “Id_{—}10_{—}1_{—}1” shown in FIG. 23, and data 7-22 for utterance estimating model shows an example of data which is based on the collected utterance analysis results 7-21 of “Id_{—}10_{—}1_{—}1” and which an utterance estimating model generator 8 uses. In this embodiment, document IDs and independent word morphemes except pronouns, particles, and prepositions are extracted.

Next, the operation of the document search device will be explained. The operation of the document search device in accordance with this Embodiment 4 (a generating process and a search process) is fundamentally the same as that shown in FIGS. 6 to 8 in accordance with above-mentioned Embodiment 1. Therefore, only a different portion will be explained hereafter. First, the generating process will be explained.

First, a generating method of generating search indexes 5 in the generating process will be explained. Hereafter, it is assumed that weighting according to tf-idf, which is disclosed by a conventional technology, is carried out. As shown in FIG. 21, it is assumed that the document 1 includes pairs in each of which a document ID is associated with a text.

For example, in the document 1-2, the name of the document ID “Id_{—}10_{—}1_{—}1” is associated with a text

[symbol]

[symbol]

[symbol]

In step ST1 of FIG. 6, an input analyzer 2 reads the document 1 having this structure in turn, and carries out a morphological analysis which is a known technology on the document so as to divide the document into morpheme strings. The results of carrying out a morphological analysis on the document 1-22 are the document analysis results 3-21 shown in FIG. 22. Although only separators for separating the morphemes are shown in these document analysis results 3-21, the document analysis results actually include pieces of part of speech information.

After document analysis results 3 are generated for each of all the document IDs, the search index generator 4, in next step ST2, extracts morphemes (keywords) required for the generation of search indexes 5 from all the document analysis results 3, generates pairs of (a document ID and a keyword list), and generates search indexes 5 on each of which weighting using tf-idf is carried out on the basis of all the pairs. The pair (a document ID and a keyword list) extracted from the document analysis results 3-21 shown in FIG. 22 is shown by data 3-22 for search indexes which is also shown in FIG. 22.

Because a concrete procedure for generating search indexes is the same as that in accordance with above-mentioned Embodiment 1, the explanation of the generating procedure will be omitted hereafter.

Next, the generating process of generating an utterance estimating model 9 will be explained. The collected utterance data 6 are data in which utterances collected in advance from the user are assigned to the document IDs of documents which are answers to the utterances, respectively, as shown as the collected utterance data 6-21 to 6-24 in FIG. 23. Because the generating method of generating the collected utterance data 6 is the same as that in accordance with above-mentioned Embodiment 1, the explanation of the generating method will be omitted hereafter.

The input analyzer 2, in step ST3 shown in FIG. 7, carries out a morphological analysis on the collected utterance data 6, like in the case of receiving, as an input, the document 1 in step ST1 previously explained. For example, the results of carrying out a morphological analysis on the collected utterance data 6-23 shown in FIG. 23 are the collected utterance analysis results 7-21 shown in FIG. 24. The utterance estimating model generator 8, in next step ST4, extracts a document ID and a list of keywords as the data 7-22 for utterance estimating model, like in the case of step ST2 previously explained, and carries out learning for the utterance estimating model 9 by using an ME method, like in the case of above-mentioned Embodiment 1. Keywords are extracted from all the collected utterance analysis results 7, and learning is carried out by using the ME method so as to generate the utterance estimating model 9. Concretely, for the collected utterance analysis results 7-21 shown in FIG. 24, the data 7-22 for utterance estimating model which is also shown in FIG. 24 is extracted, and the above-mentioned learning is carried out on the basis of this data 7-22 for utterance estimating model.

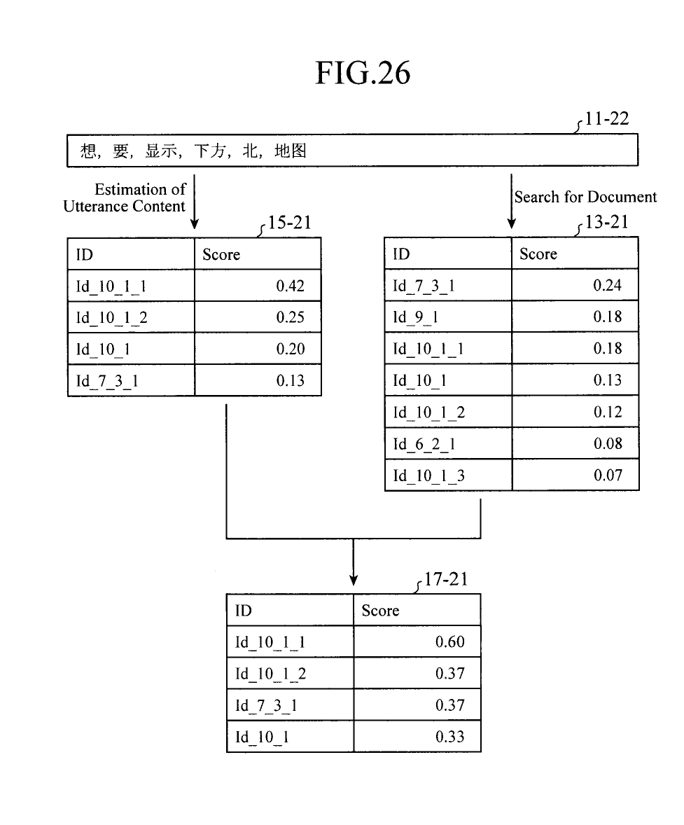

Next, the search process will be explained. FIGS. 25 and 26 are views showing an example of a transition in the search process on a user input 10-21 which is an example of the user input 10. Hereafter, it is assumed that the user input 10 is an input of a text, and an explanation will be made assuming that the user input 10-21 shown in FIG. 25 is inputted. The input analyzer 2, in step ST11 shown in FIG. 8, receives the user input 10-21 and carries out a morphological analysis on the user input first so as to generate user input analysis results 11-21, and extracts independent words excluding pronouns, particles, and introduction verbs from the user input analysis results 11-21 so as to generate a keyword list 11-22. An utterance content estimator 14, in next step ST12, uses this keyword list 11-22 as an input, and acquires document estimation results 15-21 as shown in FIG. 26 from the utterance estimating model 9. As shown in FIG. 26, the document estimation results 15-21 are arranged in a line in the order of their scores.

After the document estimation results 15-21 are acquired, a document searcher 12, in next step ST13, uses the keyword list 11-22 as an input this time and acquires document search results 13-21 shown in FIG. 26 from the search indexes 5. As shown in FIG. 26, the document search results 13-21 are also arranged in a line in the order of their scores.

A result integrator 16, in next step ST14, judges whether or not the largest score in the document estimation results 15-21 is equal to or larger than a threshold X (e.g., X=0.9) determined in this step. Because the largest score in the document estimation results 15-21 is smaller than the threshold X (when “NO” in step ST14), the result integrator 16 advances to a process of step ST16. The result integrator, in step ST16, carries out a weighting addition on each score in the document search results 13-21 and the corresponding score in the document estimation results 15-21 for each document ID so as to generate final search results 17-21. Referring to FIG. 26, the results of carrying out the addition with (each score in the document estimation results 15-21): (the corresponding score in the document search results 13-21)=1:1 are the final search results 17-21.

In contrast, when, instep ST14, the largest score in the document estimation results 15-21 exceeds the threshold X (when “YES” in step ST14) , the result integrator 16, in next step ST15, discards the document search results 13-21 and determines the document estimation results 15-21 as the final search results (not shown). After completing the search, the document search device displays the titles or the like of the document IDs on the screen so as to enable the user to select one of them, thereby presenting his or her desired document position to the user.

As mentioned above, the document search device in accordance with Embodiment 4 can carry out the same processes as those in accordance with above-mentioned Embodiment 1 not only on a Japanese document but also a Chinese document 1, and can provide the same advantages as those provided by above-mentioned Embodiment 1 also when receiving a Chinese input. Although an explanation will be omitted hereafter, the structure in accordance with Embodiment 4 can be applied to above-mentioned Embodiment 2.

While the invention has been described in its preferred embodiments, it is to be understood that, in addition to the above-mentioned embodiments, an arbitrary combination of two or more of the embodiments can be made, various changes can be made in an arbitrary component in accordance with any one of the embodiments, and an arbitrary component in accordance with any one of the embodiments can be omitted within the scope of the invention.

### INDUSTRIAL APPLICABILITY

As mentioned above, because the document search device in accordance with the present invention presents the results of performing a search of a document by using an utterance estimating model which is generated by learning a correspondence between questions generated by expecting what question the user asks and document items each of which is an answer to one of the questions in response to a user input in natural language, the document search device is suitable for use in, for example, an information device that searches through and displays an electronized operation manual for equipment, such as a home electrical appliance or vehicle-mounted equipment.

### EXPLANATIONS OF REFERENCE NUMERALS

1 document, 2 input analyzer, 3 document analysis results, search index generator, 5 search indexes, 6 collected utterance data, 7 collected utterance analysis results, 8 utterance estimating model generator, 9 utterance estimating model, 10 user input, 11 user input analysis results, 12 document searcher, 13 document search results, 14 utterance content estimator, 15 document estimation results, 16 result integrator, 17 final search results, 18 search target limiter, 19 document limit list.

1. A document search device including search indexes generated from a document which is prepared in advance, and a document searcher that receives an input from a user and searches through said document for an item associated with said user input by using said search indexes, said document search device comprising:
an utterance estimating model that is generated by learning a correspondence between hypothetical questions each as to a content of said document and items in said document each of which is an answer to one of said hypothetical questions;
an utterance content estimator that estimates an item corresponding to an answer to said user input from said document on a basis of said utterance estimating model; and
a result integrator that integrates document search results acquired from said document searcher and document estimation results acquired from said utterance content estimator so as to generate final search results.

2. The document search device according to claim 1, wherein said utterance content estimator adds a score according to a degree of association with said user input to the estimated item in said document, and, when a score in the document estimation results acquired from said utterance content estimator is larger than a predetermined value, said result integrator neglects the document search results acquired from said document searcher and generates the final search results.

3. The document search device according to claim 1, wherein said document searcher adds a score according to a degree of association with said user input to the searched-for item in said document, said utterance content estimator adds a score according to a degree of association with said user input to the estimated item in said document, and said result integrator integrates the document search results acquired from said document searcher and the document estimation results acquired from said utterance content estimator by adding the score in the document search results and the score in the document estimation results with a fixed ratio.

4. The document search device according to claim 1, wherein said document search device includes a search target limiter that extracts an item satisfying a predetermined criterion from the document estimation results acquired from said utterance content estimator, said utterance content estimator carries out the estimation on a basis of an utterance estimating model that is generated by learning a correspondence between items which are larger than a smallest unit for search using said search indexes, and said hypothetical questions, and said result integrator integrates an item extracted by said search target limiter from the document estimation results acquired from said utterance content estimator with the document search results acquired from said document searcher.

5. The document search device according to claim 1, wherein said document search device includes an input analyzer that analyzes the document prepared in advance and collected utterance data in which the correspondence between the hypothetical questions each as to a content of said document and the items in said document each of which is an answer to one of said hypothetical questions is defined, a search index generator that generates said search indexes from results of the analysis of said document outputted from said input analyzer, and an utterance estimating model generator that learns the correspondence between said hypothetical questions and the items in said document by using results of the analysis of said collected utterance data outputted from said input analyzer so as to generate said utterance estimating model.

6. A document search method comprising:
a user input step of accepting an input from a user;
a document searching step of searching through said document for an item associated with said user input by using search indexes generated from a document which is prepared in advance;
an utterance content estimating step of estimating an item corresponding to an answer to said user input from said document on a basis of an utterance estimating model that is generated by learning a correspondence between hypothetical questions each as to a content of said document and items in said document each of which is an answer to one of said hypothetical questions; and
a result integrating step of integrating document search results acquired from said document searching step and document estimation results acquired from said utterance content estimating step so as to generate final search results.
